(19) United States
(12) Patent Application Publication
(10) Pub. No.: US 2024/0005068 A1
(43) Pub. Date: Jan. 4, 2024

(54) METHOD AND SYSTEM OF WORKING CONDITION SENSITIVITY ANALYSIS AND DATA PROCESSING FOR PARAMETER IDENTIFICATION

(71) Applicant: SHANGHAI MAKESENS ENERGY STORAGE TECHNOLOGY CO., LTD., Shanghai (CN)

(72) Inventors: Pingchao Hao, Shanghai (CN); Zhimin Zhou, Shanghai (CN); Zhou Yang, Shanghai (CN); Xiao Yan, Shanghai (CN); Enhai Zhao, Shanghai (CN)

(21) Appl. No.: 18/208,416

(22) Filed: Jun. 12, 2023

(30) Foreign Application Priority Data
Jun. 30, 2022 (CN) 202210760744.8

(51) Int. Cl. G06F 30/27

(52) U.S. Cl. CPC G06F 30/27

(57) ABSTRACT

The invention provides a method and a system of working condition sensitivity analysis and data processing for parameter identification and/or for training a parameter identification neural network. The method includes according to a selected reference voltage interval, obtaining a voltage data set corresponding to electrochemical model parameters in the reference voltage interval; normalizing voltage values of the voltage data set to obtain a characteristic voltage data set, wherein the number of voltage values corresponding to different electrochemical model parameters in the characteristic voltage data set is equal; and inputting the characteristic voltage data set into a neural network model, and outputting initial values of the electrochemical model parameters to analyze the working condition sensitivity by taking the electrochemical model parameters as labels. The electrochemical model parameters include high sensitivity parameters.

### CROSS-REFERENCE TO RELATED PATENT APPLICATION

This application claims priority to and the benefit of Chinese Patent Application No. 202210760744.8, filed Jun. 30, 2022, which are incorporated herein in their entireties by reference.

### FIELD OF THE INVENTION

The invention relates generally the field of batteries, and more particularly to a method and a system of working condition sensitivity analysis and data processing for parameter identification.

### BACKGROUND OF THE INVENTION

In recent years, new energy sources such as wind power and solar power, etc. have been rapidly developed due to the increase of fossil energy crisis and environmental problems. Due to the instability of new energy systems, energy storage systems need to be introduced, and lithium ion batteries have been widely used. In order to ensure the safety and reliability of the lithium ion batteries in long-term use, a battery management system (BMS) including software and hardware is required to manage the lithium ion batteries. Currently, widely used BMSs are developed based on an equivalent circuit model (ECM). Due to the limited predictive ability of ECM, the design of battery operation strategies is based on simple safety constraints, such as: a charge cut-off voltage, a discharge cut-off voltage, a maximum current, and the like.

However, the terminal voltage cannot fully reflect the state of the inside of the battery, especially at a large current, which greatly increases or decreases the terminal voltage of the battery during charging and discharging due to large overpotentials. With the improvement of hardware computing power, a new type of more intelligent and advanced BMS based on electrochemical model (EM) is applied very fast, which can greatly improve the management ability of lithium batteries, since the EM can fully reflect the internal state of the battery, such as: lithium ion concentration distributions, potential distributions, overpotentials of positive and negative electrodes, and the like. The electrochemical model involves a large number of coupled partial differential equations and especially dozens of physical parameters, which limits the practical applications of the EM model. With the improvement of hardware capabilities, model parameters can be obtained in a data-driven manner through methods such as heuristic algorithms (genetic algorithm, particle swarm algorithm, cuckoo algorithm, etc.), neural network, and Kalman filter. The identification algorithm, for example, many identification methods for lithium battery model parameters based on heuristic algorithms, takes a long time to identify parameters and needs to measure the OCV-SOC curve of the battery in advance. However, when the battery is put into use, it is difficult to obtain the OCV-SOC curve of the battery.

Therefore, a heretofore unaddressed need exists in the art to address the aforementioned deficiencies and inadequacies.

### SUMMARY OF THE INVENTION

In view of the above-noted shortcomings, one of the objectives of this invention is to provide a method and a system of working condition sensitivity analysis and data processing for parameter identification, which solve the problems in the prior art.

In one aspect of the invention, the method of working condition sensitivity analysis and data processing for parameter identification comprises according to a selected reference voltage interval, obtaining a voltage data set corresponding to electrochemical model parameters in the reference voltage interval; normalizing voltage values of the voltage data set to obtain a characteristic voltage data set, wherein the number of voltage values corresponding to different electrochemical model parameters in the characteristic voltage data set is equal; and inputting the characteristic voltage data set into a neural network model, taking the electrochemical model parameters as labels, and outputting initial values of the electrochemical model parameters to analyze the working condition sensitivity. The electrochemical model parameters include high sensitivity parameters.

In one embodiment, before obtaining the voltage data set corresponding to the electrochemical model parameters in the reference voltage interval according to the selected reference voltage interval, the method further comprises obtaining an electric quantity and voltage curve by using a voltage change curve under a working condition; and selecting a voltage interval with a maximum electric quantity change slope as a reference voltage interval according to the electric quantity and voltage curve.

In one embodiment, the number of the voltage values of different electrochemical model parameters in the characteristic voltage data set is equal, and said normalizing the voltage values of the voltage data set to obtain the characteristic voltage data set comprises converting the voltage value of the characteristic voltage data set into a voltage value in a range of 0-1 through a normalization formula, and adjusting the number of the voltage values of different electrochemical model parameters to be the same, wherein the normalization formula is:

$$v = \frac{v - {v}_{min}}{{v}_{max} - {v}_{min}}$$

wherein v is a voltage value, vₘᵢₙ is a minimum voltage value, and vₘₐₓ is the maximum voltage value.

In one embodiment, said adjusting the number of the voltage values of the different electrochemical model parameters to be the same comprises letting the voltage data with the largest number of voltage values in the characteristic voltage data set have nₘₐₓ voltage values, and the remaining voltage data have n voltage values; if a selected voltage data is a voltage data in a charging process, the tail end of the voltage data is filled (nₘₐₓ−n) data points with a voltage value of 1; and if a selected voltage data is a voltage data in a discharging process, the tail end of the voltage data is filled (nₘₐₓ−n) data points with a voltage value of 0, so that the number of the voltage value of each piece of the voltage data in the characteristic voltage data set is adjusted to be the same, which is nₘₐₓ.

In one embodiment, the method further comprises training a neural network model; wherein the mean square error of the parameter values is taken as a loss function, and the mean square error MSE is:

$$M S E = \frac{1}{N} {\sum }_{i = 1}^{N} {( {θ}_{label , i} - {θ}_{model , i} )}^{2}$$

where MSE is the mean square error, N is the number of parameter values, i is the serial number of the parameters, and θ_{label,i} is true values of the parameter, θ_{model,i} is a predicted value of the parameters.

In one embodiment, the method further comprises inputting an initial value of the electrochemical model parameters into an electrochemical model to obtain an output voltage corresponding to the initial value of the electrochemical model parameter.

In one embodiment, the electrochemical model parameters include high-sensitivity parameters, and the high-sensitivity parameters are parameters that affect the output voltage of the electrochemical model under a constant-current condition.

In another aspect, the invention relates to a system of working condition sensitivity analysis and data processing for parameter identification, comprising an obtaining module configured to obtaining a voltage data set corresponding to electrochemical model parameters in the reference voltage interval according to the selected reference voltage interval; a preprocessing module configured to normalize voltage values of the voltage data set to obtain a characteristic voltage data set, wherein the number of voltage values corresponding to different electrochemical model parameters in the characteristic voltage data set is equal; and an output module configured to input the characteristic voltage data set into a neural network model, taking the electrochemical model parameters as labels, and output initial values of the electrochemical model parameters to analyze the working condition sensitivity, where the electrochemical model parameters include high sensitivity parameters.

In one embodiment, the system further comprises a selection module configured to obtain an electric quantity and voltage curve by using a voltage change curve under a working condition; and select a voltage interval with a maximum electric quantity change slope as a reference voltage interval according to the electric quantity and voltage curve.

In one embodiment, the preprocessing module is further configured to convert the voltage value of the characteristic voltage data set into a voltage value in a range of 0-1 through a normalization formula, and adjusting the number of the voltage values of different electrochemical model parameters to be the same, wherein the normalization formula is:

$$v = \frac{v - {v}_{min}}{{v}_{max} - {v}_{min}}$$

wherein v is a voltage value, vₘᵢₙ is a minimum voltage value, and vₘₐₓ is the maximum voltage value.

Compared with the prior art, the method and the system of working condition sensitivity analysis and data processing for parameter identification provided by the invention provide the following beneficial effects:

The invention provides a working condition selection and data processing method for training parameter identification neural network to improve the performance of neural network.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows schematically a flowchart of a method and the system of working condition sensitivity analysis and data processing for parameter identification according to one embodiment of the invention.

FIG. 2 shows a plot of discharge voltages under 1 C condition according to one embodiment of the invention.

FIG. 3 shows a plot of dq/dv-v according to one embodiment of the invention.

FIG. 4 shows a plot of three voltage data in a data set according to one embodiment of the invention.

FIG. 5 shows a plot of three shows curves according to one embodiment of the invention.

FIG. 6 shows a plot of the voltage data after data processing according to one embodiment of the invention.

FIG. 7 shows a plot of an MSELoss of the neural network training process according to one embodiment of the invention.

FIG. 8 shows a plot of voltage comparison according to one embodiment of the invention.

FIG. 9 shows a plot of voltage comparison according to one embodiment of the invention.

FIG. 10 shows schematically a block diagram of a system and the system of working condition sensitivity analysis and data processing for parameter identification according to one embodiment of the invention.

### DETAILED DESCRIPTION OF THE INVENTION

In the following description, for purposes of explanation and not limitation, specific details are set forth, such as particular system configurations, techniques, etc. in order to provide a thorough understanding of the embodiments of the invention. However, it will be apparent to one skilled in the art that the invention may be practiced in other embodiments that depart from these specific details. In other instances, detailed descriptions of well-known systems, devices, circuits, and methods are omitted so as not to obscure the description of the invention with unnecessary detail.

It should be understood that the terms “comprises” and/or “comprising”, or “includes” and/or “including”, or “has” and/or “having”, or “carry” and/or “carrying”, or “contain” and/or “containing”, or “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

It should be noted that the drawings provided in the following embodiments are merely illustrative in nature and serve to explain the principles of the invention, and are in no way intended to limit the invention, its application, or uses. Only the components related to the invention are shown in the drawings rather than the number, shape and size of the components in actual implementations. For components with the same structure or function in some figures, only one of them is schematically shown, or only one of them is marked. They do not represent the actual structure of the product. Dimensional drawing, the type, quantity and proportion of each component can be changed arbitrarily in its actual implementations. More complicate component layouts may also become apparent in view of the drawings, the specification, and the following claims.

It should be understood that, as used in the description herein and throughout the claims that follow, the meaning of “a”, “an”, and “the” includes plural reference unless the context clearly dictates otherwise. The term “and/or” as used in this specification and the appended claims refers to any and all possible combinations of one or more of the associated listed items, and includes such combinations.

It should be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

In order to more clearly illustrate the embodiments of the invention or the technical solutions in the prior art, the following description will explain the specific embodiments of the invention with reference to the accompanying drawings. It is evident that the drawings in the following description are only examples of the invention, from which other drawings and other embodiments can be obtained by a person skilled in the art without inventive effort.

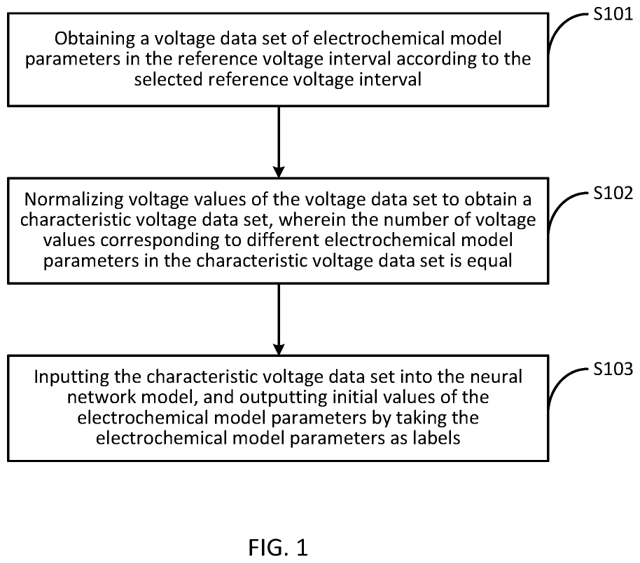

In one embodiment, as shown in FIG. 1, the method of working condition sensitivity analysis and data processing for parameter identification comprises the following steps.

At step S101, obtaining a voltage data set of electrochemical model parameters in the reference voltage interval according to the selected reference voltage interval.

Specifically, step S101 comprises step 1 of selecting voltage data under a high-sensitivity working condition for training the neural network through a dq dv-v curve, where q is an electric quantity (i.e., charge capacity of a battery), v is a voltage, dq is a change of the electric quantity and dv is a change of the voltage, dq dv is a slope (inclination degree) of the electric quantity change vs the voltage change.

The larger the dq/dv data is, the larger the change of the electric quantity of the battery at the voltage is, and the higher the inclination degree (slope) of the battery at the voltage value on the corresponding q-v curve is. The smaller the dq-dv data is, the smaller the change in the electric quantity of the battery at the voltage is, and the smaller the inclination degree (slope) of the battery at the voltage value on the corresponding q-v curve is. Since the neural network is trained by the voltage, a reference voltage interval [vₘᵢₙ, vₘₐₓ] containing a largest value of dq dv is selected according to the dq dv-v curve. One or more intervals of the voltages may be selected. It should be understood that the notation of “[A, B]”, used in the disclosure, refers to a data range of A-B, including A at the beginning and B at the end of the range.

S101 further comprises step 2 of acquiring a data set of the training neural network.

The lithium battery electrochemical model relates to dozens of physical parameters. Of them, only part of the physical parameters have influence on the output voltage of the model under the constant current working condition. Such parameters can be defined as high-sensitivity parameters, and the rest of the parameters having influence on the output voltage of the model under the high-rate or dynamic working condition are defined as low-sensitivity parameters. By adjusting the high-sensitivity parameters within a reasonable range of the battery model parameters, voltage data of the battery of this type within a selected voltage interval under a certain working condition can be generated through the electrochemical model.

It should be noted that the data may be combined with actual operation data of the battery to generate a richer and more realistic data set.

At step S102, normalizing voltage values of the voltage data set to obtain a characteristic voltage data set, wherein the number of voltage values corresponding to different electrochemical model parameters in the characteristic voltage data set is equal.

In one embodiment, step S102 specifically includes step 3 and voltage preprocessing, so as to improve the data difference.

The difference of the electrochemical model parameters affect the data volume of the set of parameters in the selected voltage interval. The data can be processed by normalizing the voltage values, according to the formula of

$$v = \frac{v - {v}_{min}}{{v}_{max} - {v}_{min}}$$

to convert all the voltage values of the characteristic voltage data set into voltage values in a range of [0, 1], and adjust the number of the voltage values of each set of parameters to be same, wherein v is a voltage value, vₘᵢₙ is a minimum voltage value, and vₘₐₓ is the maximum voltage value.

At step S103, inputting the characteristic voltage data set into the neural network model, and outputting initial values of the electrochemical model parameters by taking the electrochemical model parameters as labels.

In one embodiment, step S103 specifically includes step 4 of training the parameter identification neural network.

The voltage, current and other data in the training data set are used as the characteristic input of the training neural network, and the high-sensitivity parameters are used as the labels, and the appropriate deep learning method is selected to train the neural network. The neural network can choose CNN (convolutional neural network), LSTM (long short-term memory network), and the like.

In one embodiment, step S103 specifically includes step 5 of obtaining an initial value of the high-sensitivity parameter through a neural network.

The actual battery operation condition is preprocessed according to step 3, and then input into a trained neural network to obtain an initial value of the high-sensitivity parameter of the battery electrochemical model.

In one embodiment, the electrochemical model parameters of the full life cycle of the lithium batteries are obtained in a data driving manner that combines neural networks and heuristic algorithms, the initial value of the high-sensitivity parameters is obtained through the neural network, the number of calls of the electrochemical model can be reduced, and further, on the basis of reducing the time required by parameter identification, a method of working condition selection and data processing for training the parameter identification neural network is further provided, so that the performance of the neural network is improved.

In one embodiment, before obtaining the voltage data set of the electrochemical model parameters of the reference voltage interval according to the selected reference voltage interval, the method includes obtaining an electric quantity and voltage curve by using a voltage change curve under a working condition; and selecting a voltage interval with a maximum electric quantity change slope as a reference voltage interval according to the electric quantity and voltage curve.

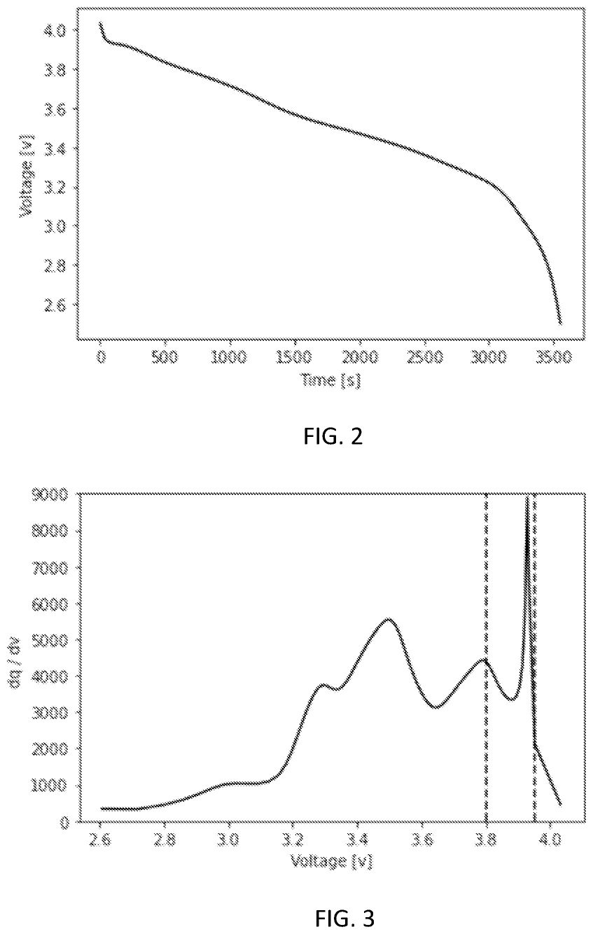

Specifically, under a certain set of parameters, the discharge curve of the battery under the 1 C condition is shown in FIG. 2, and the dq/dv-v curve shown in FIG. 3.

In the exemplary embodiment, the voltage interval with obvious characteristics is selected through the dq/dv-v curve to be used for generating the data set for training the neural network, so that the quality of the data set can be improved.

In one embodiment, said normalizing the voltage values of the voltage data set to obtain the characteristic voltage data set, wherein the number of the voltage values of different electrochemical model parameters in the characteristic voltage data set is equal, includes converting the voltage values of the characteristic voltage data set into voltage values in a range of [0 1] through a normalization formula, and adjusting the number of the voltage values of different electrochemical model parameters to be the same, wherein the normalization formula is:

$$v = \frac{v - {v}_{min}}{{v}_{max} - {v}_{min}}$$

wherein v is a voltage value, vₘᵢₙ is a minimum voltage value, and vₘₐₓ is the maximum voltage value.

In one embodiment, said adjusting the number of the voltage values of the different electrochemical model parameters to be the same comprises letting the voltage data with the largest number of voltage values in the characteristic voltage data set have nₘₐₓ voltage values, and the remaining voltage data have n voltage values; if a selected voltage data is a voltage data in a charging process, the tail end of the voltage data is filled (nₘₐₓ−n) data points with a voltage value of 1; and if a selected voltage data is a voltage data in a discharging process, the tail end of the voltage data is filled (nₘₐₓ−n) data points with a voltage value of 0, so that the number of the voltage value of each piece of the voltage data in the characteristic voltage data set is adjusted to be the same, which is nₘₐₓ.

In one embodiment, the data sets with a certain voltage range are normalized, and the lengths of different data samples are adjusted to be consistent through the padding method.

In one embodiment, the method further comprises training a neural network model; wherein the mean square error of the parameter values is taken as a loss function, and the mean square error MSE is:

$$M S E = \frac{1}{N} {\sum }_{i = 1}^{N} {( {θ}_{label , i} - {θ}_{model , i} )}^{2}$$

where MSE is the mean square error, N is the number of parameter values, i is the serial number of the parameters, and θ_{label,i} is true values of the parameter, θ_{model,i} is a predicted value of the parameters.

In one embodiment, the method also comprises inputting an initial value of the electrochemical model parameters into an electrochemical model to obtain an output voltage corresponding to the initial value of the electrochemical model parameter.

In one embodiment, the electrochemical model parameters include high-sensitivity parameters, and the high-sensitivity parameters are parameters that affect the output voltage of the electrochemical model under a constant-current condition.

One exemplary embodiment of the method for condition sensitivity analysis and data processing for training a parameter identification neural network provided by the invention is described below. The exemplary embodiment takes a ternary nickel manganese cobalt (NMC) battery as an example.

1. The Voltage Interval is Selected.

Under a certain set of parameters, the discharge curve of the battery under the 1 C working condition is shown in FIG. 2. When the current I is regarded as unit 1, the dq/dv-v curve is shown in FIG. 3. It can be seen that when the voltage is slightly greater than 3.9 v, the value of dq/dv is maximum, and the change in the voltage at this point causes the largest change of the electric quantity, and [3.8 v, 3.95 v] can be selected as the reference voltage range of the data set.

2. A Data Set is Generated Having Voltages within the Selected Voltage Interval.

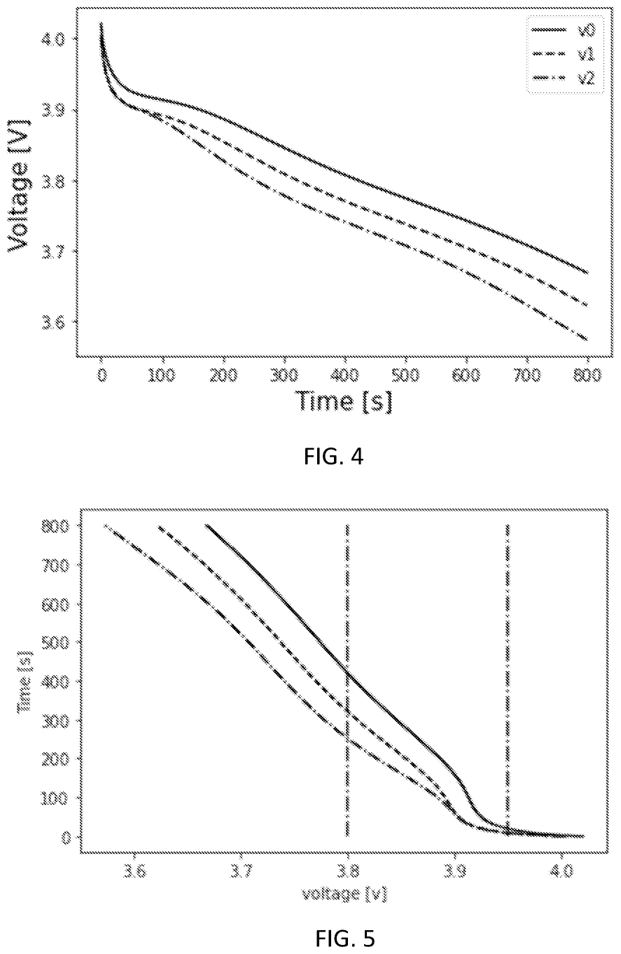

The high-sensitivity parameters are adjusted within a reasonable range, and voltage data (sampling once per second, i.e., sampling one voltage value per second) containing [3.95 v, 3.8 v](the discharge voltage is gradually reduced) is generated under the 1 C discharge working condition, and as shown in FIG. 4, the voltage data are three voltage curves in the data set.

By converting the coordinate axis of the curve of FIG. 4 to FIG. 5, one can get the conclusion of step 1, that is, when the dq/dv value is small, the electric quantity change is small.

Since q=i*t, and it is a constant current condition, the current is regarded as unit 1, that is, the slope of the t-v curve is small, where the three curves in FIG. 5 almost coincide together when v>3.95 v, which cannot be well distinguished. When the value of dq dv is large, the change in the electric quantity is large, that is, the slope of the t-v curve is large, that is, the slope of the three curves around 3.9 v in FIG. 5 is relatively large, and they can be well distinguished.

Therefore, the data whose voltage is in the range of [3.95 v, 3.8 v] is extracted from the original data set.

3. Voltages are Preprocessed.

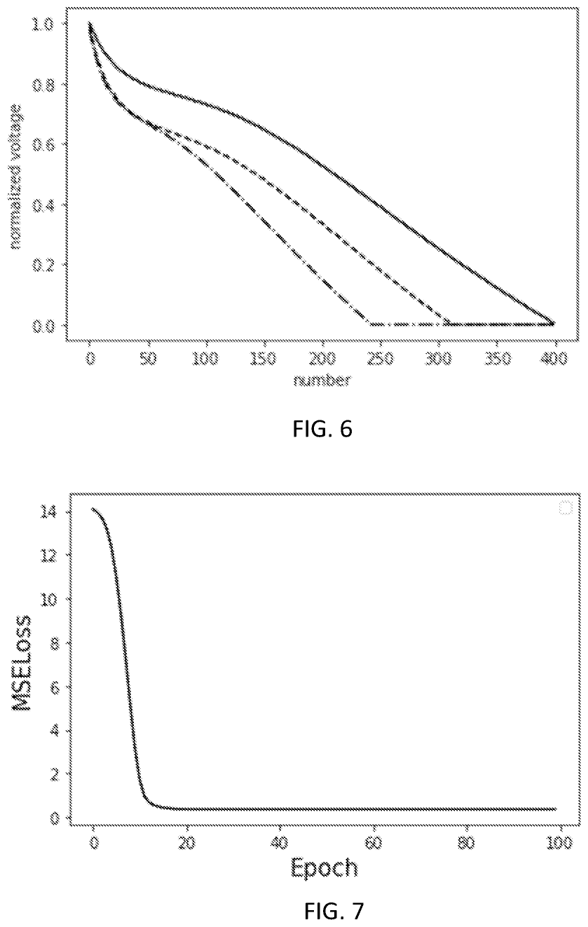

Firstly, the voltage data are normalized according to v=(v−3.8)/(3.95−3.8), and the data is then padded (filled). The longest piece of data has 400 voltage values. The voltage value contained in each piece of data is set as n according to the selected data being the data in the discharging process, and the tail end of each piece of data is filled with (400−n) data points with the voltage value of 0, so that the voltage value number of each piece of data can be adjusted to be the same, namely the voltage values are all 400, as shown in FIG. 6.

4. The Neural Network is Trained.

And inputting the actual battery operation condition into the trained neural network, and obtaining the initial value of the high-sensitivity parameter of the battery electrochemical model.

In this exemplary embodiment, LSTM is used as the network model because of its advantages in processing time series. The network is trained by inputting the voltage of the data set into the network structure as a feature, outputting the voltage as a parameter value under corresponding data, setting the training round 100 with the MSE of the parameter value as a loss function, as shown in FIG. 7, where the MSE is

$$M S E = \frac{1}{N} {\sum }_{i = 1}^{N} {( {θ}_{label , i} - {θ}_{model , i} )}^{2}$$

5. An Initial Guess for the Parameter is Obtained Through the Neural Network.

The voltage data of the battery to be identified is extracted with the voltage range of [3.95 v, 3.8 v] under the 1 C discharge condition. The extracted voltage date is then processed according to the above data processing method. The processed voltage data are input into the trained neural network, the initial value of the battery's high-sensitivity parameter can be obtained through the neural network. By substituting the initial value into the electrochemical model, the voltage output under the initial value can be obtained.

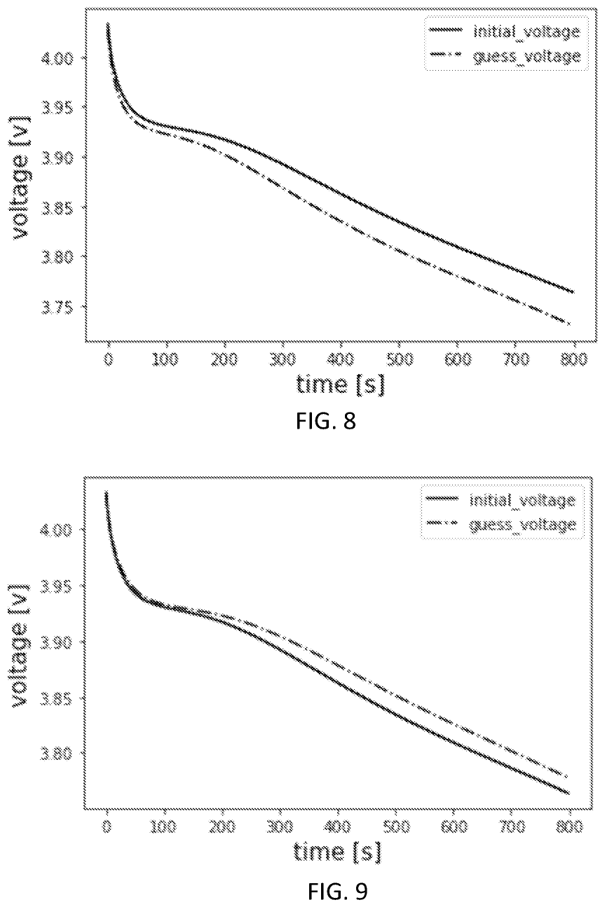

FIG. 8 is a voltage comparison graph of a neural network model trained directly on unprocessed voltage data, and FIG. 9 is a voltage comparison graph of the neural network model trained on processed voltage data. It can be seen that the performance of the neural network model identification parameter values obtained by the data processing method is better.

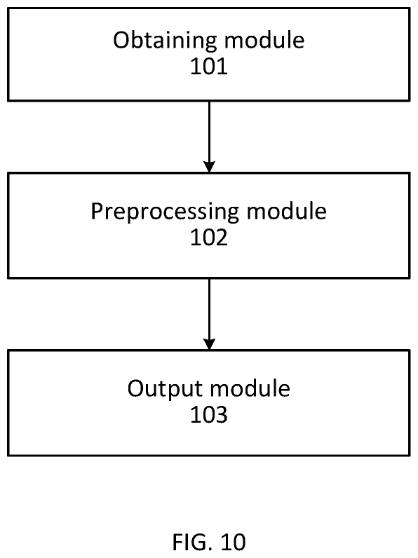

Referring to FIG. 10, a system of condition sensitivity analyzing and data processing for parameter identification is shown according to one embodiment of the invention. The system includes an obtaining module 101, a preprocessing module 102 and an output module 103.

The obtaining module 101 is configured to obtaining a voltage data set corresponding to electrochemical model parameters in the reference voltage interval according to the selected reference voltage interval. The electrochemical model parameters include high sensitivity parameters.

The preprocessing module 102 is configured to normalize voltage values of the voltage data set to obtain a characteristic voltage data set, wherein the number of voltage values corresponding to different electrochemical model parameters in the characteristic voltage data set is equal.

The output module 103 is configured to input the characteristic voltage data set into a neural network model, taking the electrochemical model parameters as labels, and output initial values of the electrochemical model parameters to analyze the working condition sensitivity.

In one embodiment, the electrochemical model parameters of the full life cycle of the lithium batteries are obtained in a data driving manner that combines neural networks and heuristic algorithms, the initial value of the high-sensitivity parameters is obtained through the neural network which can reduce the number of calls of the electrochemical model. On the basis of reducing the time required by parameter identification, a working condition selection and data processing device for training the parameter identification neural network is further proposed to improve the performance of neural networks.

In one embodiment, the system further comprises a selecting module configured to obtain an electric quantity and voltage curve by using a voltage change curve under a working condition; and select a voltage interval with a maximum electric quantity change slope as a reference voltage interval according to the electric quantity and voltage curve.

In one embodiment, the preprocessing module is further configured to convert the voltage value of the characteristic voltage data set into a voltage value in a range of [0, 1] through a normalization formula, and adjusting the number of the voltage values of different electrochemical model parameters to be the same, wherein the normalization formula is:

$$v = \frac{v - {v}_{min}}{{v}_{max} - {v}_{min}}$$

wherein v is a voltage value, vₘᵢₙ is a minimum voltage value, and vₘₐₓ is the maximum voltage value.

The invention provides a working condition selection and data processing method for training a parameter identification neural network, so as to improve the performance of the neural network.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A method of working condition sensitivity analysis and data processing for parameter identification, comprising:
according to a selected reference voltage interval, obtaining a voltage data set corresponding to electrochemical model parameters in the reference voltage interval;
normalizing voltage values of the voltage data set to obtain a characteristic voltage data set, wherein the number of voltage values corresponding to different electrochemical model parameters in the characteristic voltage data set is equal; and
inputting the characteristic voltage data set into a neural network model, and outputting initial values of the electrochemical model parameters to analyze the working condition sensitivity by taking the electrochemical model parameters as labels;
wherein the electrochemical model parameters include high sensitivity parameters.

2. The method of claim 1, wherein before obtaining the voltage data set corresponding to the electrochemical model parameters in the reference voltage interval according to the selected reference voltage interval, the method further comprises:
obtaining an electric quantity and voltage curve by using a voltage change curve under a working condition; and
selecting a voltage interval with a maximum electric quantity change slope as a reference voltage interval according to the electric quantity and voltage curve.

3. The method of claim 1, wherein said normalizing the voltage values of the voltage data set to obtain the characteristic voltage data set, wherein the number of the voltage values of different electrochemical model parameters in the characteristic voltage data set is equal, comprises:
converting the voltage values of the characteristic voltage data set into voltage values in a range of 0-1 through a normalization formula, and adjusting the number of the voltage values of different electrochemical model parameters to be the same, wherein the normalization formula is:
$$v = \frac{v - {v}_{min}}{{v}_{max} - {v}_{min}}$$
wherein v is a voltage value, vₘᵢₙ is a minimum voltage value, and vₘₐₓ is the maximum voltage value.

4. The method of claim 3, wherein said adjusting the number of the voltage values of the different electrochemical model parameters to be the same comprises:
letting the voltage data with the largest number of voltage values in the characteristic voltage data set have nₘₐₓ voltage values, and the remaining voltage data have n voltage values;
if a selected voltage data is a voltage data in a charging process, the tail end of the voltage data is filled (nₘₐₓ−n) data points with a voltage value of 1; and
if a selected voltage data is a voltage data in a discharging process, the tail end of the voltage data is filled (nₘₐₓ−n) data points with a voltage value of 0, so that the number of the voltage value of each piece of the voltage data in the characteristic voltage data set is adjusted to be the same, which is nₘₐₓ.

5. The method of claim 1, further comprising:
training a neural network model;
wherein the mean square error of the parameter values is taken as a loss function, and the mean square error MSE is:
$$M S E = \frac{1}{N} {\sum }_{i = 1}^{N} {( {θ}_{label , i} - {θ}_{model , i} )}^{2}$$
where MSE is the mean square error, N is the number of parameter values, i is the serial number of the parameters, and θ_{label,i} is true values of the parameter, θ_{model,i} is a predicted value of the parameters.

6. The method of claim 1, further comprising:
inputting an initial value of the electrochemical model parameters into an electrochemical model to obtain an output voltage corresponding to the initial value of the electrochemical model parameter.

7. The method of claim 1, wherein the electrochemical model parameters include high-sensitivity parameters, and the high-sensitivity parameters are parameters that affect the output voltage of the electrochemical model under a constant-current condition.

8. A system of working condition sensitivity analysis and data processing for parameter identification, comprising:
an obtaining module configured to obtaining a voltage data set corresponding to electrochemical model parameters in the reference voltage interval according to the selected reference voltage interval;
a preprocessing module configured to normalize voltage values of the voltage data set to obtain a characteristic voltage data set, wherein the number of voltage values corresponding to different electrochemical model parameters in the characteristic voltage data set is equal; and
an output module configured to input the characteristic voltage data set into a neural network model, taking the electrochemical model parameters as labels, and output initial values of the electrochemical model parameters to analyze the working condition sensitivity;
wherein the electrochemical model parameters include high sensitivity parameters.

9. The system of claim 8, further comprising a selection module configured to
obtain an electric quantity and voltage curve by using a voltage change curve under a working condition; and
select a voltage interval with a maximum electric quantity change slope as a reference voltage interval according to the electric quantity and voltage curve.

10. The system of claim 9, wherein the preprocessing module is further configured to:
convert the voltage value of the characteristic voltage data set into a voltage value in a range of 0-1 through a normalization formula, and adjusting the number of the voltage values of different electrochemical model parameters to be the same, wherein the normalization formula is:
$$v = \frac{v - {v}_{min}}{{v}_{max} - {v}_{min}}$$
wherein v is a voltage value, vₘᵢₙ is a minimum voltage value, and vₘₐₓ is the maximum voltage value.
